(19) United States
(12) Patent Application Publication
(10) Pub. No.: US 2026/0359077 A1
(43) Pub. Date: Nov. 12, 2026

(54) SYSTEMS AND METHODS FOR DYNAMIC GUIDED TOUR GENERATION FOR WEBSITES

(71) Applicant: Verizon Patent and Licensing Inc., Basking Ridge, NJ (US)

(72) Inventors: Nirmal Praveen Lingisetty, Andrhra Pradesh (IN); Divya Thiyagarajan, Chennai (IN); Nagarjuna Garige, Chennai (IN)

(21) Appl. No.: 19/201,989

(22) Filed: May 8, 2025

(51) Int. Cl. G06F 9/451; G06F 3/0484; G06F 40/221; G06N 20/00

(52) U.S. Cl. CPC G06F 9/451; G06F 40/221; G06N 20/00; G06F 3/0484

(57) ABSTRACT

are provided. In response to an event associated with a user accessing a website, the website is parsed to identify elements of the website. Descriptions and interface elements are generated for a guided tour of the website by processing the elements using a machine learning model. A sequence of guided tour steps are generated for the guided tour based upon the descriptions and interface elements. The sequence of guided tour steps are dynamically rendered through the website for the user.

### BACKGROUND

Many websites include functionality that explains features of a website to a user. For example, a developer of a shopping website may create hardcoded functionality that explains different buttons, links, input fields, and/or other elements of the shopping website. The hardcoded functionality may provide an explanation for how an order management interface operates, how a payment interface operates, functionality performed when a particular button is pressed, an explanation of a fillable form, etc. The hardcoded functionality may be statically defined for the website as part of developing the website.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for dynamic guided tour generation for websites, in accordance with an embodiment of the present technology;

FIG. 2 illustrates an example of a method for dynamic guided tour generation for websites, in accordance with an embodiment of the present technology;

FIG. 3 illustrates an example of a system for dynamic guided tour generation for websites, in accordance with an embodiment of the present technology;

FIG. 4A illustrate an example of a website, in accordance with an embodiment of the present technology;

FIG. 4B illustrate an example of a guided tour being dynamically generated and provided for a website, in accordance with an embodiment of the present technology;

FIG. 4C illustrate an example of a guided tour being dynamically generated and provided for a website, in accordance with an embodiment of the present technology;

FIG. 5 illustrates an example of a system for dynamic guided tour generation for websites, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for dynamic guided tour generation for websites. Interactive guided tour services generate guided tours for websites to help users understand how to most effectively use features of the websites. Creating an effective guided tour is a time consuming and resource intensive process that involves a significant amount of manual effort. For example, a developer may manually parse and process HTML of a website to manually identify key elements on a web page, such as buttons, links, and form fields. The developer manually writes description text for the guided tour such as descriptions for each step of the guided tour to describe the elements parsed from the website such as how to create a video using a video creation element. The developer manually tests and refines the guided tour to ensure a seamless user experience. The guided tours are hardcoded and static such that the guided tours cannot be dynamically updated based upon website changes such as user interface (UI) changes. Instead, a developer manually updates a guided tour with new features to take into account any changes. Additionally, different users with different language preferences may access the website, and thus a significant amount of time and effort is put into making a guided tour that adheres to different languages. In this way, the creation of conventional hardcoded and static guided tours is resource intensive and time consuming.

As provided herein, the disclosed techniques for dynamic guided tour generation improve upon conventional interactive guided tour generation by dynamically creating guided tours using automated guided tour generation functionality, which significantly reduces development time and effort. Guided tours can be dynamically and automatically generated based upon a most recent version of a website that takes into account any updates/modifications since a prior guided tour was generated. The guided tours are dynamically generated by accurately identify elements on a web page, including any recent updates/modifications such as UI changes. The elements may be input into a model such as a large language model (LLM) to create a guided tour. The automated guided tour generation functionality may utilize the model to generate descriptive text to create clear and concise descriptions, such as through natural language processing. The automated guided tour generation functionality takes into account a user language selection so that the model can automatically generate localized titles and descriptions for the guided tour, and thus the guided tour adheres to internationalization where different users may have different language preferences. The automated guided tour generation functionality takes into account and adheres to accessibility standards so that the guided tour implements accessibility features (e.g., generating large font, providing audio descriptions for text, etc.).

In some embodiments, the automated guided tour generation functionality is invoked to generate descriptions and interface elements to include within a guided tour for a website. In some embodiments, the generation of the guided tour is invoked/triggered based upon a user accessing the website. The automated guided tour generation functionality generates the descriptions and interface elements by processing elements extracted from the website such as text, buttons, links, form fields, etc. In some embodiments, the elements may be processed using natural language processing, models, or other processing functionality capable of generating descriptions and interface elements. A sequence of guided tour steps are created for the guided tour based upon the descriptions and interface elements (e.g., an interface element may be surfaced/rendered with a description for button of the website). In this way, the sequence of guided tour steps are rendered through the website to the user.

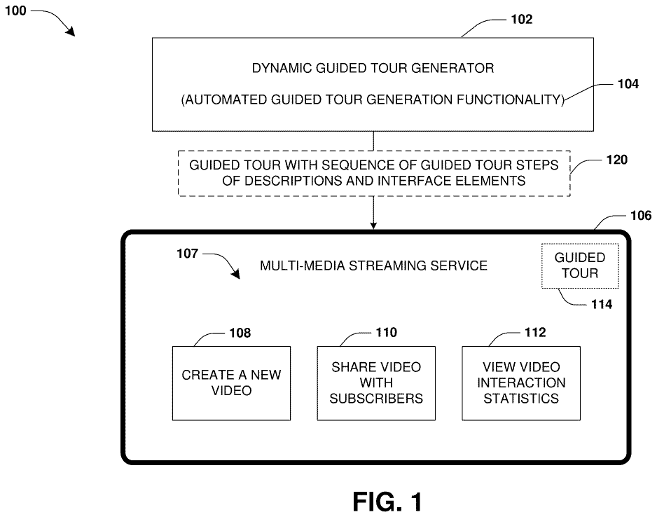

FIG. 1 illustrates an example of a system 100 for dynamic guided tour generation for websites. The system 100 may include a dynamic guided tour generator 102 hosting or having access to automated guided tour generation functionality 104. In some embodiments, the dynamic guided tour generator 102 may be hosted on a client device 106 accessing a multi-media streaming service website 107, on a server hosting the multi-media streaming service website 107, or any other computing device capable of transmitting guided tour data to the client device 106 for display. The dynamic guided tour generator 102 may dynamically and automatically generate guided tours for the multi-media streaming service website 107 based upon an occurrence of an event such as a user visiting the multi-media streaming service website 107, the user invoking guided tour functionality 114, etc.

In response to detecting the occurrence of the event, the dynamic guided tour generator 102 parses the multi-media streaming service website 107 to identify elements of the multi-media streaming service website 107, such as a create new video element 108, a share video with subscribers element 110, a view video interaction statistics element 112, and/or other buttons, links, forms, or user interface elements of the multi-media streaming service website 107. The dynamic guided tour generator 102 invokes the automated guided tour generation functionality 104 to generate descriptions and interface elements. The descriptions and interface elements are generated to create a guided tour 120 of the multi-media streaming service website 107. In some embodiments, the descriptions and interface elements are generated by processing the parsed elements using natural language processing that can output textual descriptions based upon information extracted from the elements by the natural language processing. The descriptions and interface elements may include text within a text box, an image, a video, a link to content, or other content that may be displayed as a guided tour step to the user to provide a guided description for an element (e.g., a description for how to create a new video using the create new video element 108, a description for how to share videos using the share video with subscribers element 110, etc.).

A sequence of guided tour steps are created based upon the descriptions and interface elements as the guided tour 120. For example, a guided tour step may include a description and/or an interface element for an element of the multi-media streaming service website 107, such as a textbox interface element with a description for how to use the view video interaction statistics element 112. The dynamic guided tour generator 102 may determine an order for the guided tour steps according to a determined logical ordering. The determined logical ordering may relate to a logical sequence, flow, or journey that a user would take through the website. For example, a user may first create a video, then share the video, and finally view interaction statistics for the video. Accordingly, a guided tour step for the create new video element 108 may be ordered/presented first, a guided tour step for the share video with subscribers element 110 may be ordered/presented second, and a guided tour step for the view video interaction statistics element 112 may be ordered/presented third. In this way, the sequence of guided tour steps may be rendered through the multi-media streaming service website 107 for the user.

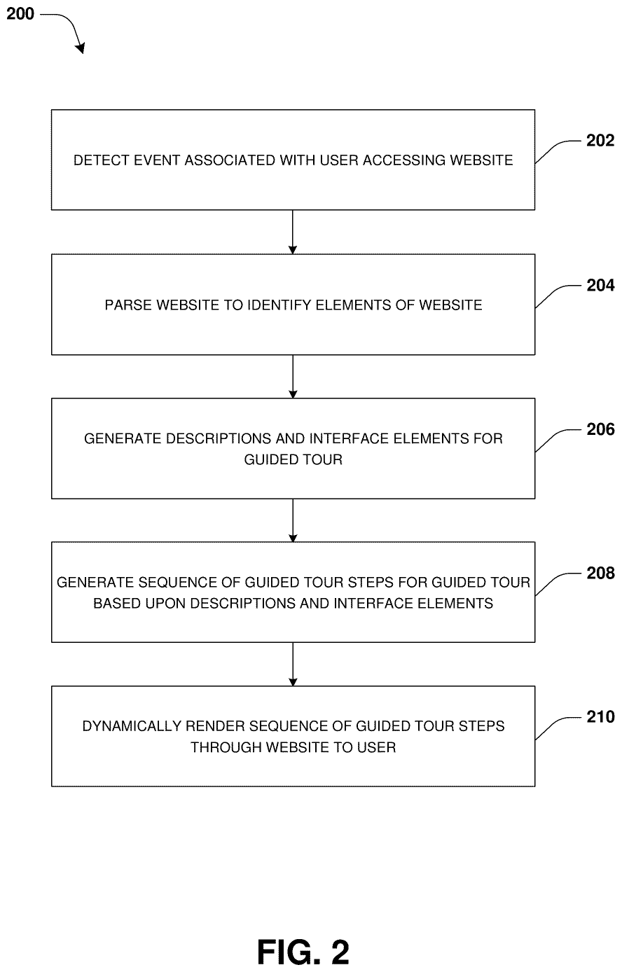

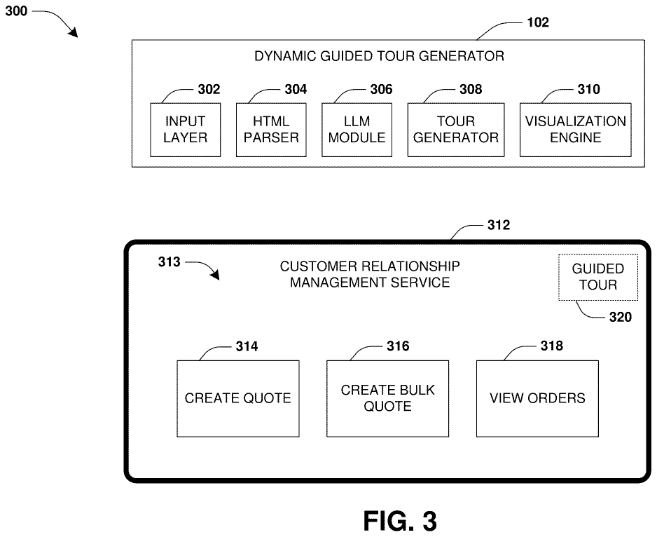

FIG. 2 illustrates an example of a method 200 for dynamic guided tour generation for websites, which is described in conjunction with system 300 of FIG. 3. The system 300 may include the dynamic guided tour generator 102 hosting the automated guided tour generation functionality for dynamically generating guided tours for a customer relationship management (CRM) service website 313. In some embodiments, the dynamic guided tour generator 102 may be hosted as part of a guided tour extension that is enabled for a device 312 used by a user to access the CRM service website 313. The guided tour extension may dynamically create a guided tour for the user based upon occurrence of an event.

The dynamic guided tour generator 102 hosts a frontend layer that includes an input layer 302 and a parser 304 such as an HTML parser. The input layer may be hosted as part of a web application frontend that monitors user input through the CRM service website 313, such as to determine whether the user has accessed the CRM service website 313 or has interacted with an element on the CRM service website 313 such as a create quote element 314, a create bulk quote element 316, a view orders element 318, a start guided tour element 320, etc. During operation 202 of method 200, the input layer 302 may detect an event associated with the user accessing the CRM service website 313 such as the user visiting the CRM service website 313 for the first time through the device 312 or the user invoking the start guided tour element 320. In some embodiments, dynamic and automated generation of a guided tour is triggered based upon the event such as the user accessing the CRM service website 313 or the user initiating a guided tour option through the start guided tour element 320.

In response to detecting the occurrence of the event, the parser 304 extracts elements from the CRM service website 313, such as the create quote element 314, the create bulk quote element 316, the view orders element 318, accessibility elements (e.g., aria-label, alt, title, etc.), and/or other elements such as buttons, inputs, forms, interactive elements, etc., during operation 204 of method 200. The parser 304 may parse HTML of the CRM service website 313 to identify the elements of the CRM service website 313. The frontend layer sends the parsed elements such as UI elements to a backend layer (e.g., a thin backend for frontend) that accesses or controls one or more models such as models hosted by an LLM module 306 controlled by the automated guided tour generation functionality.

During operation 206 of method 200, descriptions and interface elements are generated (e.g., using AI and machine learning functionality) for the guided tour of the CRM service website 313. In some embodiments, natural language processing is used to process the elements extracted from the CRM service website 313 to generate the descriptions and interface elements. In some embodiments, the LLM module 306 is controlled to use a model such as a pre-trained LLM to generate user friendly descriptions for the elements extracted from the CRM service website 313. In some embodiments, the LLM module 306 parses the elements and outputs descriptions, buttons, and UI elements that will be shown to the user in a particular order through a guided tour interface.

In some embodiments of generating the descriptions and elements, accessibility elements are extracted from the CRM service website 313. Accessibility metadata for an accessibility element is input into a model to generate a description for the accessibility element. The description may be used to generate a guided tour step for the accessibility element as part of the guided tour. In this way, guided tour steps can be created according to an accessibility standard (e.g., large font, audio description for text, etc.). In some embodiments, a model such as an LLM is used to localize the descriptions and titles based upon a user language selection (e.g., German, English, or other language particular to the user visiting the CRM service website 313). The localized descriptions and titles are used to create guided tour steps in a particular language for the user.

During operation 208 of method 200, a sequence of guided tour steps are generated for the guided tour based upon the descriptions and interface elements generated by the automated guided tour generation functionality. In some embodiments, a guided tour step includes a description that will be displayed through an interface element such as a pop-up (e.g., guided tour step for the create quote element 314 may include a pop-up with a description for how to create a quote using functionality of the create quote element 314). In some embodiment, triggers may be defined for surfacing and displaying the interface elements of the guided tour (e.g., a user interacting with a first guided tour step or clicking away from the first guided tour step may trigger the display of a second guided tour step ordered next in sequence).

In some embodiments, the guided tour is generated based upon text generated by a large language model and accessibility elements extracted from a document object model of the CRM service website 313. In some embodiments, the sequence of guided tour steps are generated to include step by step instructions (e.g., steps for creating a quote, step for creating a bulk quote, steps for viewing orders, etc.), visual cues (e.g., an arrow pointing from a create quote description to the create quote element 314), and/or interactive elements.

In some embodiments, the descriptions are mapped to the elements of the CRM service website 313 (e.g., the description for the create quote element 314 is mapped to the create quote element 314 as a guided tour step for the create quote element 314). In some embodiments, the sequence of guided tour steps and element specific popups (e.g., a popup displaying a description for a particular element of the CRM service website 313) are generated by combing data parsed from the CRM service website 313 and descriptions output by a large language model. In some embodiments, the sequence of guided tour steps are generated to include a tour interface through which instructions are displayed, and the guided tour includes logic/functionality to highlight relevant elements on the CRM service website 313 for corresponding instructions being currently displayed (e.g., the view orders element 318 may be highlighted when instructions explaining how to view orders are being displayed through the tour interface).

In some embodiments, the guided tour is generated by a tour generator 308 that is part of the frontend layer. The tour generator 308 utilizes outputs from the backend layer and/or the LLM module 306 (e.g., the descriptions and interface elements) to construct a guided tour that includes an ordered sequence of the guided tour steps. The frontend layer may include a visualization engine 310 that dynamically renders the guided tour to display the sequence of guided tour steps through the CRM service website 313 to the user, during operation 210 of method 200. In some embodiments, the visualization engine 310 renders the descriptions and interface elements according to an order of the sequence of guided tour steps. In some embodiments, the guided tour is dynamically rendered on an application user interface (the tour interface) by highlighting elements and displaying corresponding descriptions (step by step instructions), popups, interface elements (interactive elements), or other information for elements of CRM service website 313, such as through display in tooltips.

The dynamic guided tour generator 102 may monitor user interaction with the CRM service website 313 and/or the guided tour. The user interaction may relate to web pages amongst which the user has navigated, elements of the website with which the user has interacted, guided tour steps with which the user has interacted, etc. Behavior of the guided tour may be adjusted based upon the user interaction, such as where the guided tour steps may be reordered, skipped, or new guided tour steps may be dynamically created based upon what content/elements with which the user has interacted. The dynamic guided tour generator 102 may dynamically update the guided tour based upon detected changes and modifications to the CRM service website 313 such as where elements are added, removed, or modified within the CRM service website 313. The automated guided tour generation functionality may be dynamically adapted to take into account the modifications and changes so that the dynamic guided tour generator 102 can update the guided tour according, such as by adding, removing, or modifying guided tour steps, descriptions, interface elements, step by step instructions, etc. using the adapted automated guided tour generation functionality. In this way, the guided tour may be dynamically generated and modified in real-time while the user is accessing the CRM service website 313.

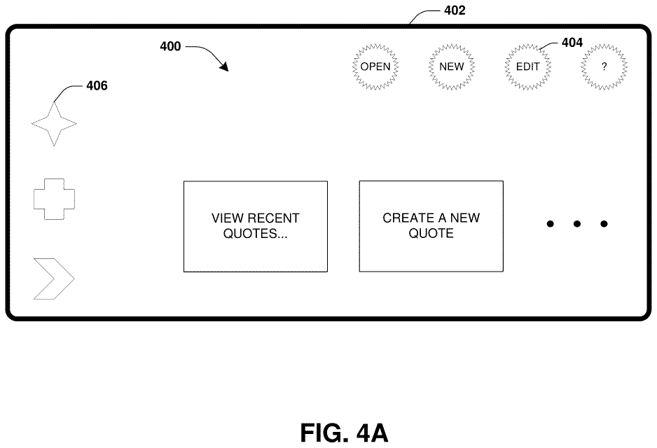

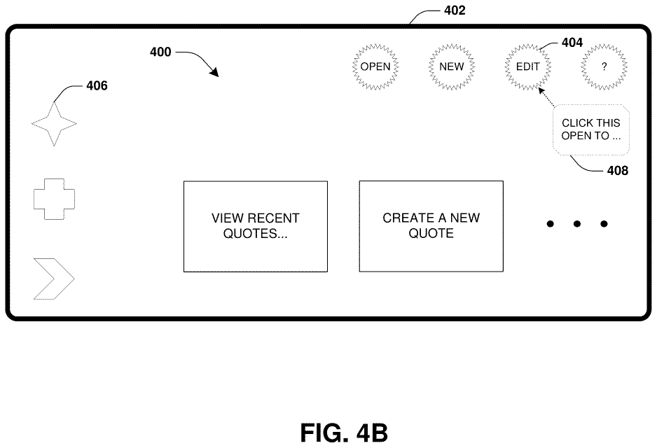

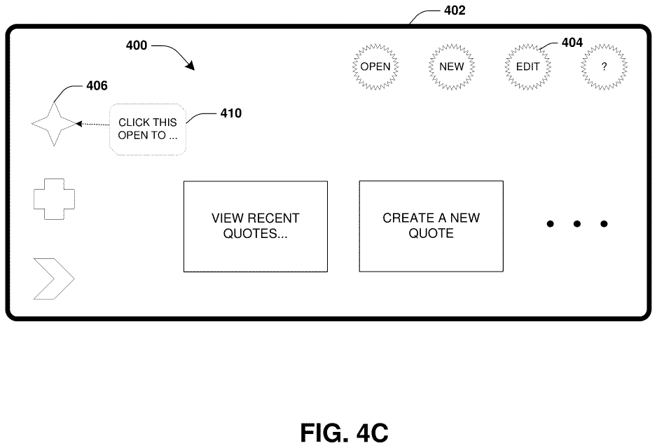

FIG. 4A-4C illustrate an example of a guided tour being dynamically generated and provided for a website 400. The website 400 may include elements, such as buttons, input boxes, fillable forms, UI elements, or other website elements. For example, the website might include a button 406, an edit element 404, a view recent quotes element, a create new quote element, and/or other elements. The dynamic guided tour generator 102 may detect an event associated with the website 400, such as a user accessing the website 400 through a device 402.

In response to detecting the event, the dynamic guided tour generator 102 dynamically constructs a guided tour comprising a series of guided tour steps dynamically generated using automated guided tour generation functionality and/or models such as large language models. The guided tour steps may be provided to the user according to a particular order, which may be dynamically determined and modified based upon user interaction with the website 400 and/or the guided tour. For example, a first guided tour step 408 may be displayed for the edit element 404, as illustrated by FIG. 4B. The first guided tour step 408 may describe step by step instructions for how to use the edit element 404. Subsequent the display of the first guided tour step 408, a second guided tour step 410 may be displayed for the button 406, as illustrated by FIG. 4C. The second guided tour step 410 may be displayed/surfaced based upon a trigger such as a user clicking away from the first guided tour step 408 or clicking a next button. The second guided tour step 410 may describe step by step instructions for how to use the button 406. In this way, various guided tour steps of the guided tour are provided to the user according to a specified ordering and/or in response to detecting triggers for transitioning between guided tour steps.

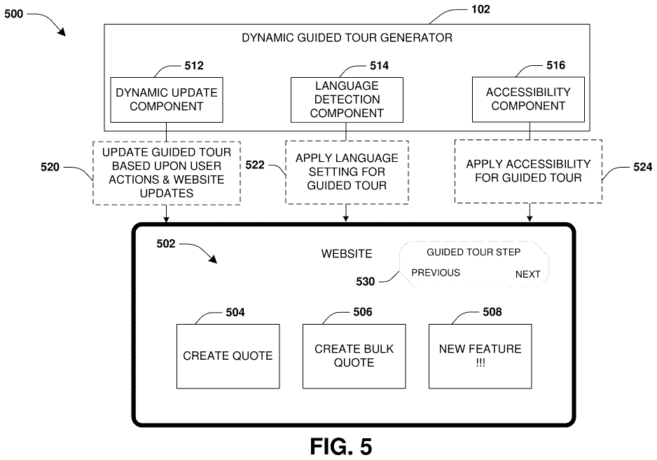

FIG. 5 illustrates an example of a system 500 for dynamic guided tour generation for websites. The system 500 includes the dynamic guided tour generator 102 configured to dynamically generate guided tours for a website 502. The 502 website may initially include a create quote element 504 and a create bulk quote element 506. The dynamic guided tour generator 102 may initially create a guided tour based upon the create quote element 504 and the create bulk quote element 506. As part of creating the guided tour, the dynamic guided tour generator 102 utilizes a language detection component 514 to apply 522 a language setting to the guided tour based upon a language preference or setting of the user so that the guided tour is dynamically adjusted for various languages and locations. The dynamic guided tour generator 102 utilizes an accessibility component 516 to apply 524 accessibility for the guided tour (e.g., increase font size, add audio descriptions for text, etc.) so that the guided tour adheres to accessibility standards. The accessibility may be derived from existing accessibility elements of the website 502, such as aria-label, alt, and title.

The guided tour may include a guided tour step 530 that may be displayed based upon a trigger. The guided tour step 530 may include a previous button to navigate to a previous guided tour step that is sequentially ordered before the guided tour step. The guided tour step 530 may include a next button to navigate to a next guided tour step that is sequentially ordered after the guided tour step.

The dynamic guided tour generator 102 may utilize a dynamic update component 512 to dynamically update 520 the guided tour based upon user interaction with the website 502 and/or the guided tour (e.g., the user may focus on a particular element, and thus a guided tour step may be dynamically generated and provided to the user or an existing guided tour step for the element may be reordered/re-sequenced for display next). The dynamic guided tour generator 102 may utilize the dynamic update component 512 to dynamically update 520 the guided tour based upon modifications to the website 502 such as the addition of a new feature element 508. For example, the guided tour may be updated with a new guided tour step for the new feature element 508. In this way, the dynamic guided tour generator 102 automatically generates and/or dynamically updates guided tours for the website 502.

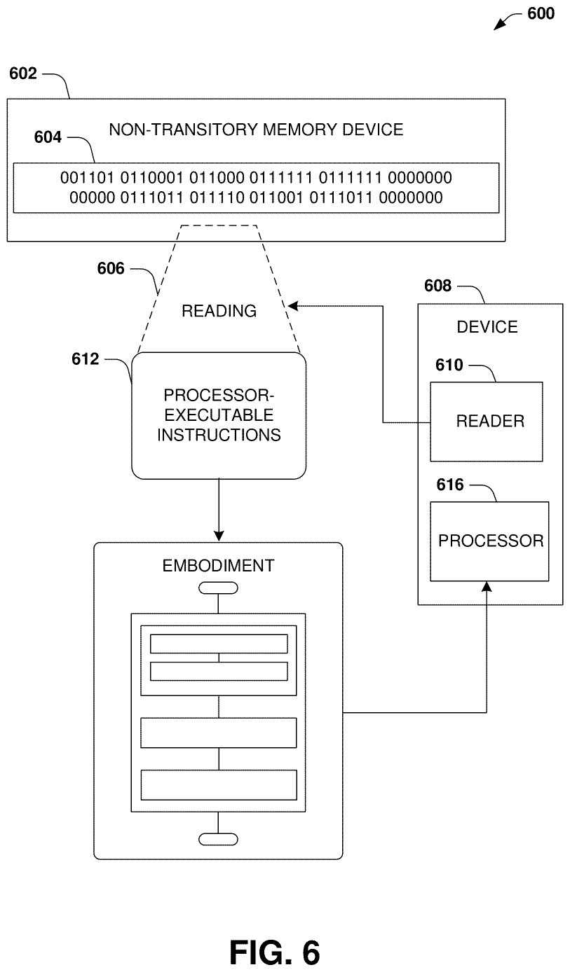

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1 and/or at least some of the example system 300 of FIG. 3, for example.

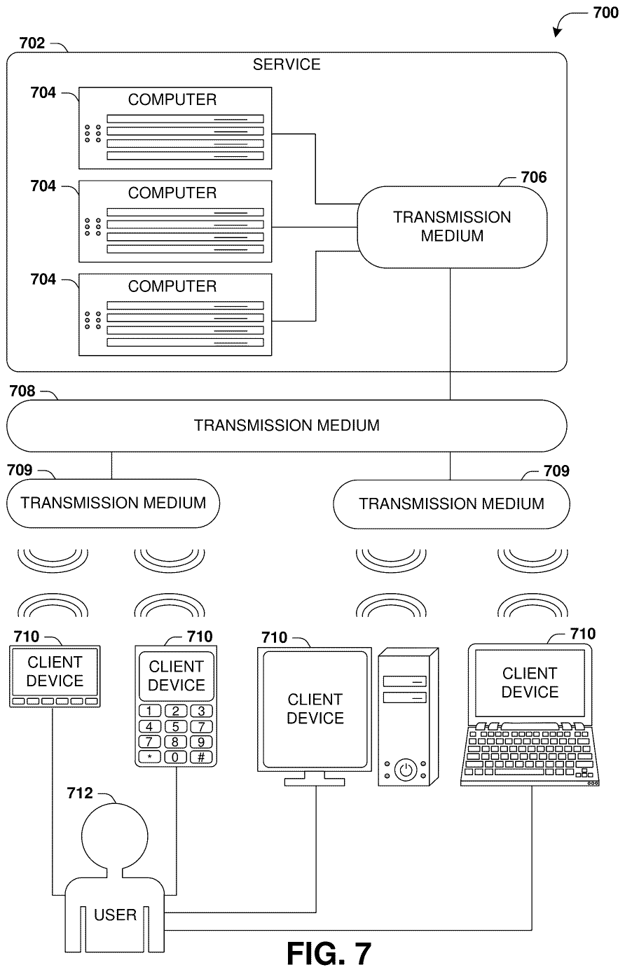

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

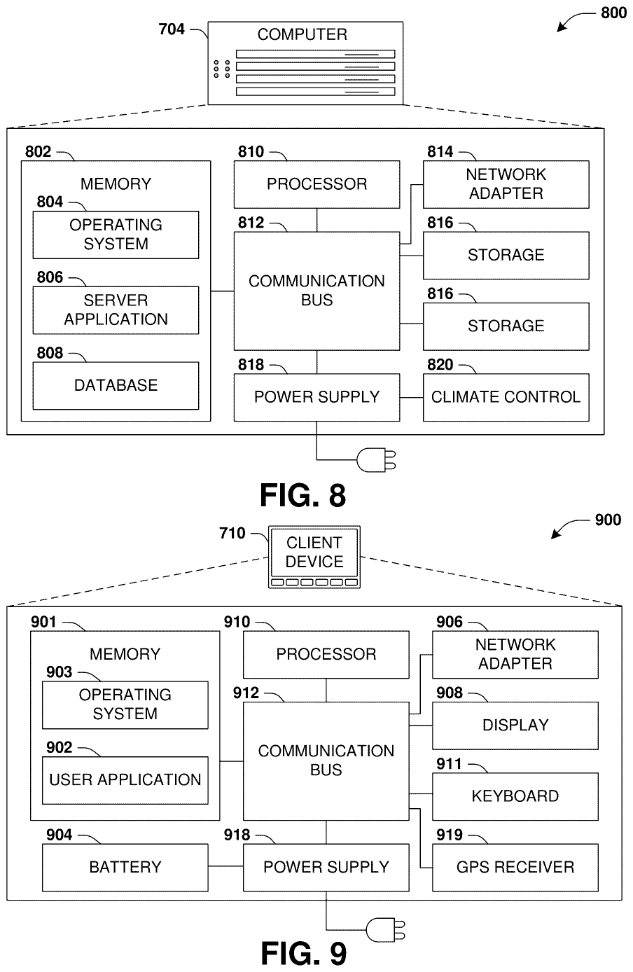

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
in response to detecting an event associated with a user accessing a website, parsing the website to identify elements of the website;
generating descriptions and interface elements for a guided tour of the website by processing the elements using a machine learning model;
generating a sequence of guided tour steps for the guided tour based upon the descriptions and interface elements; and
dynamically rendering the sequence of guided tour steps through the website to the user.

2. The method of claim 1, wherein the generating the sequence of guided tour steps includes:
mapping the descriptions of the guided tour to the elements of the website.

3. The method of claim 1, wherein the generating the sequence of guided tour steps includes:
defining triggers for surfacing the interface elements of the guided tour.

4. The method of claim 1, comprising:
monitoring user interaction with at least one of the website or the guided tour; and
adjusting behavior of the guided tour based upon the user interaction.

5. The method of claim 1, comprising:
identifying a modification to the website; and
dynamically adapting the machine learning model to take into account the modification for updating the guided tour.

6. The method of claim 1, comprising:
extracting an accessibility element from the website;
inputting accessibility metadata of the accessibility element into a model to generate a description; and
generating, based upon the description, a guided tour step for the accessibility element as part of the guided tour.

7. The method of claim 1, comprising:
enabling a guided tour extension for a device used by the user to access the website, wherein the guided tour extension dynamically creates the guided tour as the user accesses the website.

8. The method of claim 1, comprising:
generating the guided tour based upon text generated by a large language model and accessibility elements extracted from a document object model.

9. The method of claim 1, comprising:
executing the guided tour to render the descriptions and interface elements according to an order of the sequence of guided tour steps.

10. A system, comprising:
one or more processors configured for executing instructions to perform operations comprising:
in response to detecting an event associated with a user accessing a website, parsing the website to identify elements of the website;
generating descriptions and interface elements for a guided tour of the website by processing the elements using a machine learning model;
generating a sequence of guided tour steps for the guided tour based upon the descriptions and interface elements; and
dynamically rendering the sequence of guided tour steps through the website to the user.

11. The system of claim 10, wherein the operations further comprise:
utilizing a large language model to localize the descriptions and titles based upon a user language selection.

12. The system of claim 10, wherein the operations further comprise:
dynamically triggering the generation of the sequence of guided tour steps based upon a determine that the user has accessed the website.

13. The system of claim 10, wherein the operations further comprise:
dynamically triggering the generation of the sequence of guided tour steps based upon the user initiating a guided tour option for the website.

14. The system of claim 10, wherein the operations further comprise:
generating the sequence of guided tour steps according to an accessibility standard.

15. The system of claim 10, wherein the operations further comprise:
generating the sequence of guided tour steps to include step by step instructions, visual cues, and interactive elements.

16. The system of claim 10, wherein the operations further comprise:
generating the sequence of guided tour steps to include a tour interface through which instructions are displayed and relevant elements on the website are highlighted.

17. A non-transitory computer-readable medium storing instructions that when executed by one or more processors facilitate performance of operations comprising:
in response to detecting an event associated with a user accessing a website, parsing the website to identify elements of the website;
generating descriptions and interface elements for a guided tour of the website by processing the elements using a machine learning model;
generating a sequence of guided tour steps for the guided tour based upon the descriptions and interface elements; and
dynamically rendering the sequence of guided tour steps through the website to the user.

18. The non-transitory computer-readable medium of claim 17, wherein the operations further comprise:
automatically updating the guided tour based upon a detected change to the website.

19. The non-transitory computer-readable medium of claim 17, wherein the operations further comprise:
combining data parsed from the website and large language model descriptions to create the sequence of guided tour steps and element specific pop-ups.

20. The non-transitory computer-readable medium of claim 17, wherein the operations further comprise:
dynamically rendering the guided tour on an application user interface by highlighting elements and displaying corresponding descriptions for the elements in tooltips.
